(19) United States
(12) Patent Application Publication
(10) Pub. No.: US 2002/0131528 A1
(43) Pub. Date: Sep. 19, 2002

(54) System and method of parallel partitioning a satellite communications modem

(75) Inventors: Richard Clewer, Ijamsville, MD (US); Neal Becker, Frederick, MD (US); Richard Smith, Walkersville, MD (US); J. Mark Steber, Frederick, MD (US); Yezdi Antia, Gaithersburg, MD (US)

Correspondence Address: Hughes Electronics Corporation, Patent Docket Administration, Bldg. 1, Mail Stop A109, P.O. Box 956, El Segundo, CA, 90245-0956, US

(73) Assignee: HUGHES ELECTRONICS

(21) Appl. No.: 10/043,803

(22) Filed: Jan. 10, 2002

Related U.S. Application Data
(60) Provisional application No. 60/260,839, filed on Jan. 10, 2001.

(51) Int. Cl. H04L 27/06

(52) U.S. Cl. 375/316; 375/332

(57) ABSTRACT

A demodulator for use in a satellite communication system, which is operative for receiving a modulated signal having a data rate R (i.e., the demodulator receives R input samples per second). The demodulator includes a demultiplexer circuit having N shift registers, which functions to receive the R data samples per second as an input signal. The demultiplexer circuit operates to input the R input samples sequentially into the N shift registers such that each of the shift registers receives input samples at a data rate of R/N samples per second. The demodulator further includes signal recovery circuitry for processing the input samples contained in each of the N shift registers so as to regenerate the data contained in the incoming modulated signal transmitted by the satellite.

### RELATED APPLICATIONS

This application claims priority under 35 U.S.C. §119(e) to provisional application Serial No. 60/260,839, filed Jan. 10, 2001.

### FIELD OF THE INVENTION

The present invention relates to modems for use in satellite communication systems and more particularly, to the demodulator contained in such modems, which is operative for receiving and restoring/demodulating the incoming data from the satellite.

### BACKGROUND OF THE INVENTION

The use of modems in satellite communication systems is well known in the art. Generally speaking, modems contain both modulators and demodulators. The modulator's function is to convert the data (i.e., to be transmitted) generated by a given end user to a format suitable for transmission by the satellite system. The demodulator receives the incoming “modulated” signal and demodulate the signal so as to restore/regenerate the data transmitted by the satellite to the given end user.

In order to accommodate the “throughput” or bandwidth necessary for satellite communication systems to execute the multitude and types of applications (e.g., high speed internet access systems) in a manner acceptable to end users, it is necessary for modems to operate at exceedingly high data rates. For example, in a satellite communication system designed to provide a certain bandwidth, it could be necessary for the demodulator of the modem to sample incoming data at an 800 MHz rate. However, utilizing current technologies, the maximum clock speeds available for demodulators is on the order of 200 MHz. It is noted that, while demodulators operating at speeds of 800 MHz may be possible, such demodulators would be exceedingly expensive, and could not be utilized in any commercially viable product/system.

Accordingly, there exists a need for a demodulator for use in a satellite communication system that allows for demodulation of incoming data running at data rates exceeding the maximum clock speed of the demodulator.

### SUMMARY OF THE INVENTION

The present invention relates to a demodulator for use in a satellite communication system that allows for the demodulation and reproduction of incoming data, which has a data rate exceeding the maximum clock speed of the demodulator. In other words, the demodulator of the present invention is capable of processing “high-speed” incoming data, utilizing “low-speed” logic circuitry, thereby making the demodulator economically viable.

More specifically, the present invention relates to a demodulator for use in a satellite communication system, which is operative for receiving a modulated signal having a data rate R (i.e., the demodulator receives R input samples per second). The demodulator includes a demultiplexer circuit having N shift registers, which functions to receive the R data samples per second as an input signal. The demultiplexer circuit operates to input the R input samples sequentially into the N shift registers such that each of the shift registers receives input samples at a data rate of R/N samples per second. The demodulator further includes signal recovery circuitry for processing the input samples contained in each of the N shift registers so as to regenerate the data contained in the incoming modulated signal transmitted by the satellite.

In addition, the present invention relates to a method of demodulating an incoming modulation signal for use in a satellite communication system, where the incoming modulation signal has a data rate R. The method includes the steps of: (1) partitioning the modulation signal into N data channels, each of the data channels operating at a data rate equal to R/N; (2) processing the modulation signal contained in each of the N data channels at a data rate of R/N so as to regenerate the data transmitted by the satellite (which is contained in the modulated signal); and (3) outputting the resultant data signal.

As described below, the parallel partitioned satellite demodulator of the present invention provides important advantages over prior art devices. Most importantly, the demodulator allows for the demodulation of incoming high speed data utilizing circuitry operating at reduced data rates. As a result, the demodulator of the present invention provides an economical solution for satellite communications systems, which require the ability to process high speed data. As explained in more detail below, even assuming demodulators were capable for running at such high speed data rates, the cost of such demodulators would preclude the satellite communication system from being a commercially viable system. It is further noted that in addition to cost issues, any demodulator running at the high speed data rate would also likely have significant power dissipation requirements, thereby further increasing the cost associated with such a modulator. In contrast, as the demodulator of the present invention runs below the high speed data rate of the incoming data, the power dissipation requirements associated with the demodulator are minimized.

Additional advantages of the present invention will become apparent to those skilled in the art from the following detailed description of exemplary embodiments of the present invention.

### BRIEF DESCRIPTION OF THE DRAWINGS

FIG. 1 is a block diagram of an exemplary data demodulator for use in a satellite communication system in accordance with the present invention.

FIG. 2 is a block diagram illustrating a prior art serial implementation of a FIR filter.

FIGS. 3a-3e are block diagrams illustrating an exemplary implementation of a parallel FIR filter utilized in the satellite demodulator in accordance with the present invention.

The invention itself, together with further objects and attendant advantages, will best be understood by reference to the following detailed description, taken in conjunction with the accompanying drawings.

### DETAILED DESCRIPTION OF THE DRAWINGS

The following detailed description of the partitioned satellite data demodulator of the present invention sets forth exemplary embodiments of the device. It is noted, however, that the present invention as claimed herein is not intended to be limited to the specific embodiments disclosed in the following discussion. Clearly other implementations of the novel data demodulator for use with the satellite communication system are possible.

FIG. 1 is a block diagram of an exemplary data demodulator for use in a satellite communication system in accordance with the present invention. It is noted that the exemplary demodulator illustrated in FIG. 1 is utilized in a satellite communication system designed to receive a QPSK waveform having a data rate of 400M symbols-per second. As two samples per symbol are typically utilized in conjunction with QPSK modulation, the demodulator must have an effective sampling rate of 800 MHz. However, as noted above, current “ASIC” technology only allows for maximum clock rates on the order of 200 MHz. Thus, it is not possible to run the demodulator at a clock rate of 800 MHz. The demodulator of the present invention solves this problem by partitioning the incoming data into four separate parallel channels, each of which runs at a data rate which is ¼ of the incoming data rate of 800 MHz. As such, the demodulator of the present invention allows for the demodulation of the incoming 800 MHz sample-per-second QPSK data stream (i.e., each of the four channels runs at a data rate of 200 MHz).

Referring again to FIG. 1, as shown therein, the exemplary demodulator 10 comprises a dual A/D converter 12, which receives analog quadrature data (I and Q data) as an input signal and converts the I and Q analog signals into a digital format. The output of the A/D converter 12 is coupled to a demultiplexer circuit 14. It is noted that both the A/D converter 12 and the demultiplexer circuit 14 are clocked at the “high speed” data rate, as prior to the demultiplexer 14, the incoming data signal has not yet been partitioned in parallel channels.

As explained in more detail below, the demultiplexer 14 functions to partition both the I data channel and the Q data channel output by the A/D converter 12 into four separate channels, each of which is running at ¼ of the incoming data rate. To summarize the operation, assuming the inputs to the demultiplexer are I(n) and Q(n), representing the digital samples of the incoming I and Q data, respectively, the output signals generated by the demultiplexer 14 are I₀(n), I₁(n), I₂(n) and I₃(n), which represent the four parallel channels of I data, and Q₀(n), Q₁(n), Q₂(n) and Q₃(n), which represent the four parallel channels of Q data. As each I data sample is received by the demultiplexer 14, the incoming data is sequentially routed to one of the four I data channels. For example, data sample “n” is routed to data channel I₀; data sample “n+1” is then routed to data channel I₁; data sample “n+2” is then routed to data channel I₂; data sample “n+3” is routed to data channel I₃; and data sample “n+4” is again routed to data channel I₀, and the process continues in this manner. Data is placed in the four Q data channels in the same manner. Accordingly, as stated, the output of the demultiplexer is four I data channels, each of which is running at ¼ the rate of the incoming data signal, and four Q data channels, each of which is also running at ¼ the rate of the incoming data signal. In the given embodiment, the demultiplexer 14 also provides an input clock signal 25 for the remaining components of the demodulator 10. As shown in FIG. 1, the clock signal output by the demultiplexer 14 operates at ¼ the clock rate of the incoming data signal 21.

Referring again to FIG. 1, the demodulator 10 further comprises a complex mixer circuit 16, a symbol timing interpolator circuit 18, a matched filter circuit 20, a carrier recovery circuit 22, a numerically controlled oscillator 24, a soft decision circuit 26, a viterbi decoder 28, a Reed-Solomon decoder 30 and a descrambler circuit 32. The complex mixer circuit 16, the symbol timing interpolator circuit 18, the matched filter circuit 20, the carrier recovery circuit 22, and the numerically controlled oscillator 24, function to form a carrier recovery loop, which operates to track the frequency and phase offsets and adjust them such that the samples are optimized. As shown, the output of the complex mixer circuit 16, which comprises the four parallel I data channels and the four parallel Q data channels, is coupled to the symbol timing interpolator circuit 18. Similarly, the output of the symbol timing interpolator circuit 18 comprises the four parallel I data channels and the four parallel Q data channels, which are coupled to the input of the matched filter circuit 20. The carrier recovery circuit 22 receives output signals generated by the matched filter circuit 20. The output of the carrier recovery circuit 22 is coupled to the numerically controlled oscillator 24, the output of which is coupled to the complex mixer circuit 16, thereby completing the carrier recovery loop.

Continuing, the output of the matched filter circuit 20 is also coupled to the soft decision circuit 26. The matched filter circuit 20 functions to maximize the signal to noise ratio so as to optimize the symbols forwarded to the soft decision circuit 26. The output of the soft decoder circuit 26 is coupled to the viterbi decoder 28. The output of the viterbi decoder 28 is coupled to the Reed-Solomon decoder 30, the output of which is coupled to the descrambler circuit 32.

It is noted that the individual components illustrated in the exemplary demodulator 10 depicted in FIG. 1 are standard components, the function and operation of which are well known by those skilled in the art of modem design. As a result, the functional description of the operation of the individual components is omitted from the detailed description. Indeed, it is the decomposition of the incoming data into a plurality of parallel processing channels, each of which operates at a reduced data rate, and the recombination of these processing channels by the demodulator of the present invention that in-part distinguishes the present invention over the prior art. It is further noted that the decomposition and associated processing of the multiple parallel channels is essentially the same for the each of the components of the demodulator requiring parallel partitioning capabilities. As such, the partitioning scheme utilized in the demodulator of the present invention will be illustrated in detail utilizing the finite impulse response filter portion of the matched filter circuit 20.

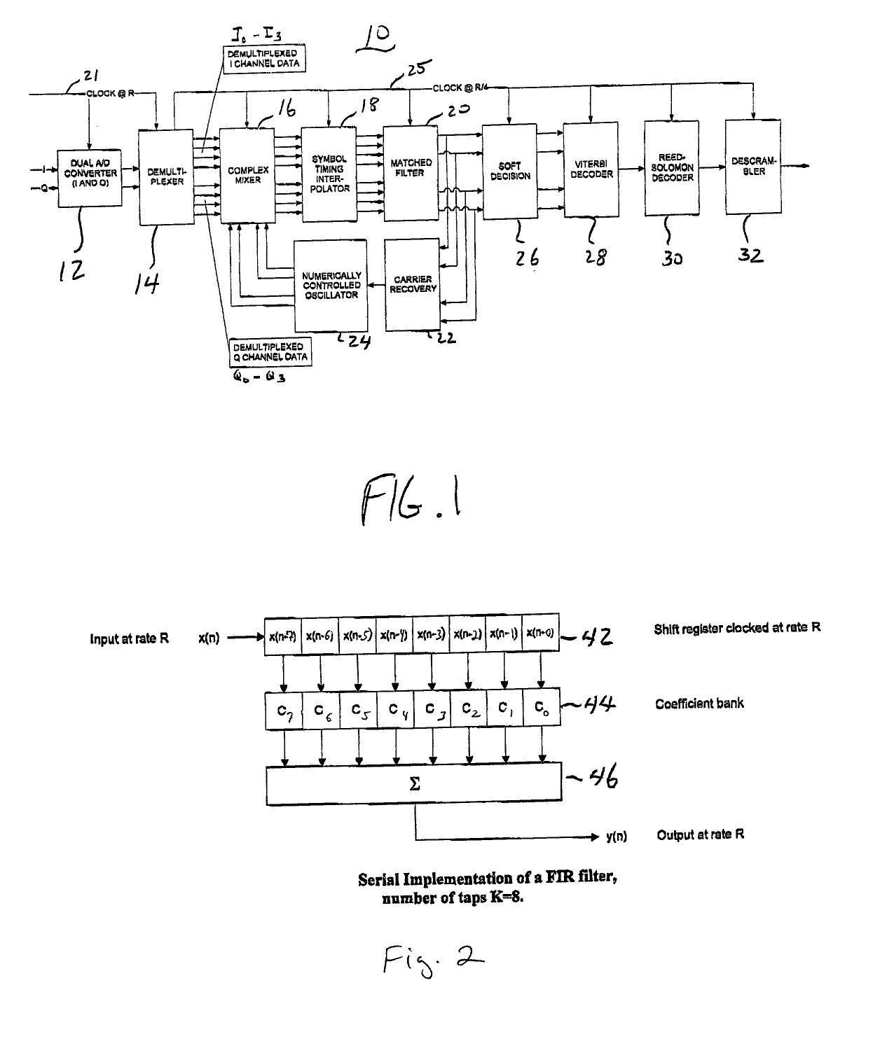

In understanding the parallel processing of the present invention, it is helpful to first understand the serial implementation of the given component (which is this instance is the FIR filter). FIG. 2 illustrates a serial implementation of a FIR filter, which represents the prior art. As shown in FIG. 2, the FIR filter comprises a shift registrar 42 having a predetermined length (e.g., in the example shown, 8 taps). Input data samples, denoted x(n), is continually clocked into the shift register at data rate R. The FIR filter further includes a coefficient bank 44 having predetermined coefficients C₀-C₇, which are multiplied with the corresponding data samples. The resulting values of the multiplication between the data samples and the coefficients are then coupled to a summer 46 and added together. The output of the summer 46, which is denoted y(n), is the output of the FIR filter.

More specifically, the FIR filter processes input samples x(n) to create output samples y(n) at a sample clock rate R in accordance with the following equation:

$$y ( n ) = {\sum }_{k = 0}^{K} {C}_{k} x ( n - k ) \qquad Eq . ( 1 )$$

where x(n) it the input sequence at time n, Cₖ is the k^{th} FIR filter coefficient, K is the number of FIR filter coefficients and the filter length in taps, and y(n) is the output sequence at time n. In order for the FIR filter of FIG. 2 to process incoming data having a data rate of 800 MHZ, the FIR filter must also be run at a rate of 800 MHZ.

As noted above, the present invention functions to reduce the necessary processing rate of the components forming the demodulator from the maximum data rate of the incoming data, R. In the example described herein, the processing data rate is reduced by a factor of four by partitioning the operation of the FIR filter into four parallel channels for both the I and Q data signals. It is noted that the reduction factor can be varied by adding or reducing the number of partitioning channels as necessary.

Continuing, in order to perform the same FIR operation at a clock rate equal to R/N, where N is the sample-to-clock rate ratio (an integer greater than 1), it is necessary to combine groups of N inputs and output samples into “timeslices”. For example, if N=4 and K=8, then a serial input sequence x(n), x(n−1), . . . , x(n−11), would be grouped into 3 timeslices of 4 parallel samples as defined by:

$$X = [ {X}_{0} ] [ {X}_{4} ] [ {X}_{8} ] = [ \begin{matrix}x ( n - 3 ) \\ x ( n - 2 ) \\ x ( n - 1 ) \\ x ( n - 0 )\end{matrix} ] [ \begin{matrix}x ( n - 7 ) \\ x ( n - 6 ) \\ x ( n - 5 ) \\ x ( n - 4 )\end{matrix} ] [ \begin{matrix}x ( n - 11 ) \\ x ( n - 10 ) \\ x ( n - 9 ) \\ x ( n - 8 )\end{matrix} ] \qquad Eq . ( 2 )$$

which represents how the samples would be stored in N shift registers of length int(K/N+1). Input vectors X are generically denoted as:

$${X}_{j} = [ \begin{matrix}x ( n - j - 3 ) \\ x ( n - j - 2 ) \\ x ( n - j - 1 ) \\ x ( n - j )\end{matrix} ] \qquad Eq . ( 3 )$$

The output vectors Y are generated from the filter and are represented as:

$${Y}_{j} = [ \begin{matrix}y ( n - j - 3 ) \\ y ( n - j - 2 ) \\ y ( n - j - 1 ) \\ y ( n - j )\end{matrix} ] \qquad Eq . ( 4 )$$

where j=0, N, 2N, . . . is the timeslice index.

Importantly, however, the output vector elements are still computed using the serial equation set forth in Eq. (1). Thus, by parallel partitioning of the FIR filter and processing the data in accordance with the foregoing equation, the maximum data rate required by a given channel is N times less than the incoming data rate R, however the end result remains the same as that when utilizing the serial processing implementation. Accordingly, the present invention allows for a reduction in the processing requirements of the FIR filter (i.e., in the current example the maximum necessary speed of the FIR filter was reduced from 800 MHz to 200 MHz), without any reduction in performance.

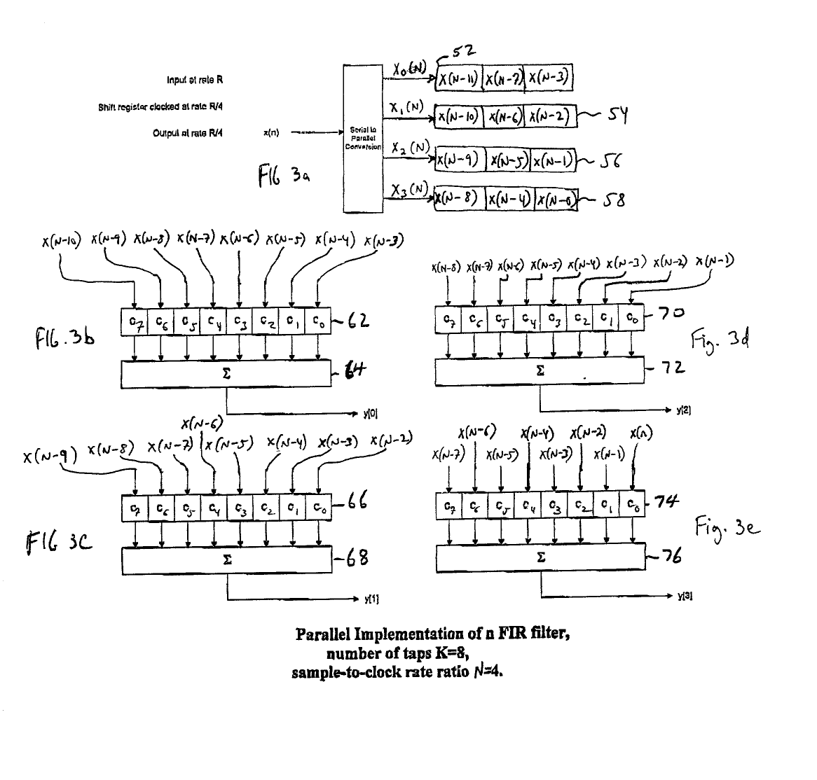

FIGS. 3a- 3e are block diagrams illustrating an exemplary implementation of a parallel FIR filter of the demodulator in accordance with the present invention. Referring first to FIG. 3a, the incoming data signal x(n), which is clocked at a rate of R, is clocked into four shift registers 52, 54, 56 and 58 in a sequential manner such that a given shift register receives every fourth data bit of input data x(n) as an input signal. The data rate associated with each input vector is R/4. FIGS. 3(b)-3(e) illustrate the generation of the four corresponding output vectors y(0), y(1), y(2) and y(3). As shown, each stage of the four shift registers is fed to the corresponding coefficient bank 62, 66, 70 and 74, which functions to multiply the given data samples contained in the corresponding shift register by predetermined coefficients. Each coefficient bank is fed to a corresponding summer 64, 68, 72 and 76, which functions to generate the output vectors y(0), y(1), y(2) and y(3). The output vectors y(0)-y(3) are then utilized to generate the resultant output signal y(n) as defined by Eq. 1, which represents the output of the FIR filter.

It is again noted that the foregoing discussion regarding the implementation of partitioned FIR filter of the demodulator of the present invention is intended to be illustrative of the novel partitioning utilized by the satellite communication demodulator of the present invention. The FIR filter was selected for illustration of the partitioning concept due to the relative straight-forward mathematical functions performed by the FIR filter, which allow for the partitioning concept to be readily shown. Referring again to the block diagram of the demodulator of the present invention illustrated in FIG. 1, of the components set forth therein, each of the demultiplexer circuit 14, the complex mixer circuit 16, the symbol timing interpolator circuit 18 and the matched filter (FIR) circuit 20 process data in the partitioned mode described above. However, it is also noted that once the incoming data is partitioned into the separate plural data channels running at a reduced data rate, which is done by the demultiplexer circuit 14 in the current embodiment, the remaining circuits operating in a parallel processing mode may not need to repartition the data. In other words, as shown in FIG. 1, in the given example, the complex mixer circuit 16, the symbol timing interpolator circuit 18 and the matched filter (FIR) circuit 20 simply receive the partitioned data lines (i.e., four lines for I data and four lines for Q data) each of which has a data rate of R/4. As such, these circuits can perform the necessary function on each corresponding partitioned data line, and then couple the output data to the subsequent circuit.

Referring again to FIG. 1, it is further noted that not all eight partitioned data channels are received as inputs to the soft decision circuit 26 or the carrier recovery circuit 22 in the illustrated embodiment of the demodulator. This is due to the fact that both the soft decision circuit 26 and the carrier recovery circuit 22 require receipt of only one sample per symbol for proper operation of the intended function.

As described above, the parallel partitioned satellite communication demodulator of the present invention provides important advantages over prior art devices. Most importantly, the demodulator allows for the demodulation of incoming high speed data utilizing circuitry operating at reduced data rates. As a result, the demodulator of the present invention provides an economical solution for satellite communications systems, which require the ability to process high speed data. It is further noted that because the demodulator of the present invention runs below the high speed data rate of the incoming data, there is no increase in the power dissipation requirements associated with the demodulator.

It is further noted that variations of the exemplary embodiment discussed above of the demodulator of the present invention are also possible. For example, the demodulator can be utilized with modulation techniques other than QPSK modulation. In fact, the demodulator can be utilized with any suitable modulation technique.

Furthermore, as already noted, the desired data rate reduction can be controlled by varying the number of channels the incoming data is partitioned into. It is noted, however, that the selected reduction in data rate must be sufficient so as to allow the demodulator to generate output data in a manner sufficient to satisfy other system requirements.

Of course, it should be understood that a wide range of other changes and modifications can be made to the preferred embodiment described above. It is therefore intended that the foregoing detailed description be regarded as illustrative rather than limiting and that it be understood that it is the following claims including all equivalents, which are intended to define the scope of the invention.

What is claimed is:

1. A demodulator for use in a satellite communication system, said demodulator operative for receiving a modulated signal having a data rate R, said modulated signal comprising retrievable data, said demodulator comprising:
means for partitioning said modulated signal into N data channels, each of said data channels having a data rate equal to R/N; and
means for processing the modulated signal contained in each of said N data channels at a data rate of R/N, said means for processing operative for regenerating and outputting said retrievable data.

2. The demodulator of claim 1, wherein said means for partitioning said modulated signal into N data channels comprises a demultiplexer, said demultiplexer operative for receiving samples of said modulated signal at a data rate R samples per second, and for outputting one of said received samples to one of said data channels at a data rate of R/N samples per second.

3. The demodulator of claim 2, wherein said demultiplexer operates to output one of said received samples to each of said data channels at a data rate of R/N samples per second.

4. The demodulator of claim 1, wherein said means for partitioning said modulated signal into N data channels generates a clock signal having a rate of R/N, said clock signal be coupled to and utilized to clock the means for processing the modulated signal.

5. The demodulator of claim 1, wherein said modulated signal is generated utilizing QPSK modulation.

6. The demodulator of claim 1, wherein said data rate R is approximately 800 MHz.

7. A demodulator for use in a satellite communication system, said demodulator operative for receiving a modulated signal having a data rate R such that said demodulator receives R input samples per second, said modulated signal comprising retrievable data, said demodulator comprising:
a demultiplexer circuit having N shift registers, said demultiplexer circuit receiving said R samples per second as an input signal, said demultiplexer operative for inputting said R input samples sequentially into said N shift registers such that each of said shift registers receives input samples at a data rate of R/N samples per second; and
signal recovery circuitry for processing the input samples contained in each of said N shift registers so as to regenerate said retrievable data.

8. The demodulator of claim 7, wherein said demultiplexer generates a clock signal having a rate of R/N, said clock signal be coupled to and utilized to clock the signal recovery circuitry for processing the modulated signal.

9. The demodulator of claim 7, wherein said modulated signal is generated utilizing QPSK modulation.

10. The demodulator of claim 7, wherein said data rate R is approximately 800 MHz.

11. A method of demodulating an incoming modulation signal for use in a satellite communication system, said incoming modulation signal having a data rate R, said modulation signal comprising retrievable data, said method comprising the steps of:
partitioning said modulation signal into N data channels, each of said data channels having a data rate equal to R/N;
processing the modulation signal contained in each of said N data channels at a data rate of R/N so as to regenerate said retrievable data; and
outputting said retrievable data.

12. The method of claim 11, wherein said step of partitioning said modulation signal into N data channels further comprises the step of outputting one of said received samples to one of said data channels at a data rate of R/N samples per second.

13. The method of claim 12, wherein said step of partitioning said modulation signal into N data channels further comprises the step of outputting one of said received samples to each of said data channels at a data rate of R/N samples per second.

14. The method of claim 11, wherein said step of partitioning said modulation signal into N data channels further comprises generating a clock signal having a rate of R/N, said clock signal be coupled to and utilized in the step of processing the modulation signal.

15. The method of claim 11, wherein said modulated signal is generated utilizing QPSK modulation.

16. The method of claim 11, wherein said data rate R is approximately 800 MHz.

17. A method of demodulating an incoming modulation signal for use in a satellite communication system, said incoming modulation signal having a data rate R such that R input samples per second are received, said modulation signal comprising retrievable data, said method comprising the steps of:
demultiplexing the incoming modulation signal utilizing N shift registers, said demultiplexing step comprising inputting said R input samples sequentially into said N shift registers such that each of said shift registers receives input samples at a data rate of R/N samples per second; and
processing the input samples contained in each of said N shift registers utilizing signal recovery circuitry so as to regenerate said retrievable data.

18. The method of claim 17, wherein said demultiplexing step comprises generating a clock signal having a rate of R/N, said clock signal being coupled to and utilized by said signal recovery circuitry.

19. The method of claim 17, wherein said modulated signal is generated utilizing QPSK modulation.

20. The method of claim 17, wherein said data rate R is approximately 800 MHz.
